(19) United States
(12) Patent Application Publication
(10) Pub. No.: US 2005/0118560 A1
(43) Pub. Date: Jun. 2, 2005

(54) System, method and program for selecting and retrieving information related to an audio-visual presentation

(75) Inventor: Fernando Incertis Carro, Valencia (ES)

Correspondence Address: IBM CORPORATION, IPLAW IQ0A/40-3, 1701 NORTH STREET, ENDICOTT, NY, 13760, US

(73) Assignee: INTERNATIONAL BUSINESS MACHINES CORPORATION, ARMONK, NY (US)

(21) Appl. No.: 10/993,231

(22) Filed: Nov. 18, 2004

Related U.S. Application Data
(63) Continuation-in-part of application No. PCT/EP03/05258, filed on Apr. 18, 2003.

(51) Int. Cl. G09B 3/00

(52) U.S. Cl. 434/350

(57) ABSTRACT

A system, method and program product for enabling an audience member, during the course of a presentation, to select one or a plurality of topics of interest and after the presentation, to access more information related to the selected topic(s). The system and method are based on a synchronization of the local times of the speaker workstation and audience member's devices, so that the times at which selections of interesting topics are made by audience members can be correlated with the time intervals during which the presentation foils are presented by the speaker.

### BACKGROUND OF THE INVENTION

This is a Continuation-in-Part of PCT Application serial number EP03/05258 filed Apr. 18, 2003.

The present invention relates generally to computer systems and software, and more particularly to access of information relating to an audio-visual presentation.

Known presentation systems allow a presenter to create electronic foils, slides or pages and to assemble them to form a presentation that can be displayed. Such presentation systems are used, during the course of a presentation, to select and display electronic foils to an audience. Known presentation systems also allow a presenter to advance to the next foil, to return to the previous foil or to go to any other foil within the presentation using a graphical user interface or a keyboard. The presenter also has the option to navigate from one foil to another, for example, to skip some foils, to present the more relevant foils of the presentation, or to present foils requested by members of the audience.

A known presentation system can generate or reference a sequence of HTML files stored on one or a plurality of Web servers. Each of these HTML files may be accessible by activating a hyperlink from the presentation system. The hyperlink comprises an address for locating the HTML file in the network for example, an Uniform Resource Locator URL in the Internet network. During the presentation, the presenter can present all or a subset of the HTML foils depending on the timing of the presentation, the interest shown by the audience members, or any other factor. Therefore, the presentation of foils and related topics can flow sequentially or in any other convenient order, depending on the course that the presentation takes and the amount of time spent for each topic i.e., the time to explain each chart or slide of the presentation.

Often, audience members are interested in some but not other of the topics which are presented, and may want additional information about the topics of interest.

Accordingly, it is an object of the invention to enable audience members to readily obtain additional information about topics of interest.

### SUMMARY OF THE INVENTION

The present invention resides in a system, method and program product for supplying information to an audience member. A first computing device is used to initiate presentation of a plurality of informational screens during respective time intervals to the audience member. The first computing device records start and stop times for the presentation of each of the informational screens. During the presentation of one of the informational screens, the audience member, using a second computing device, requests additional information about the one informational screen. In response, the second computing device records a time that the audience member made the request. Then, the time that the audience member made the request is compared to the start and stop times for the presentation of each of the informational screens. Based on the comparison, a determination is made that the audience member made the request during the presentation of the one presentation screen.

In accordance with a feature of the present invention, based on the determination that the one informational screen was presented when the audience member made the request, the second computing device is supplied with the additional information about the one informational screen or hyper links to the additional information about the one informational screen.

### BRIEF DESCRIPTION OF THE FIGURES

FIG. 1 shows audience members perceiving topics of interest when listening to a speaker and viewing presentation foils.

FIG. 2 illustrates synchronization of the speaker workstation and the audience member workstations according to a same universal-time.

FIG. 3 is a table listing a sequence of HTML presentation foils referenced in a Presentation Hyperlink Table.

FIG. 4 shows how a speaker workstation uses the Presentation Hyperlink Table to select HTML foils, how these HTML foils are retrieved and presented, and how the universal times corresponding to the presentation of these HTML foils by the speaker are stored in a Presentation Time Table according to the present invention.

FIG. 5 shows an example of the Presentation Time Table generated during a presentation and stored on a Presentation Server according to the present invention.

FIG. 6 shows how, during a presentation, an audience member selects a topic by pressing a key on his or her workstation according to the present invention.

FIG. 7 shows how the universal times, at which topics are selected by the audience member, are stored in a Selections Time Table located in the audience member workstation according to the present invention.

FIG. 8 shows how, when the presentation ends, the audience member updates the Selections Time Table located in his or her workstation from the Presentation Time Table stored in the Presentation Server.

FIG. 9 is a table with pointers illustrating how names and URLs of HTML foils that have been presented by the speaker and selected by the audience member, are identified and retrieved from the Presentation Time Table located in the Presentation Server and how the Selections Time Table located in the audience member workstation is updated according to the present invention.

FIG. 10 shows how from the updated Selections Time Table, the audience member activates a hyperlink to a selected HTML foil according to the present invention.

FIG. 11 shows how the presentation HTML foil that corresponds to the audience member selection is received from the Web server and displayed on the audience member computing device.

FIG. 12 is a time graph showing how the foils presented by the speaker and the selections made by the audience members are correlated using a same universal-timing system.

FIG. 13 is a flow chart illustrating a method for creating a Presentation Hyperlink Table on the speaker workstation according to the present invention.

FIG. 14 is a flow chart illustrating a method for generating, during a presentation, a Presentation Time Table on a Presentation Server, according to the present invention.

FIG. 15 is a flow chart illustrating a method for selecting one or several topics of interest during a presentation, according to the present invention.

FIG. 16 is a flow chart illustrating a method for accessing information related to topics that have been selected during a presentation, according to the present invention.

FIG. 17 is a block diagram illustrating the components of an audience member computing device, a speaker/presenter computing device and a presentation server, according to the present invention.

### DETAILED DESCRIPTION OF THE PREFERRED EMBODIMENTS

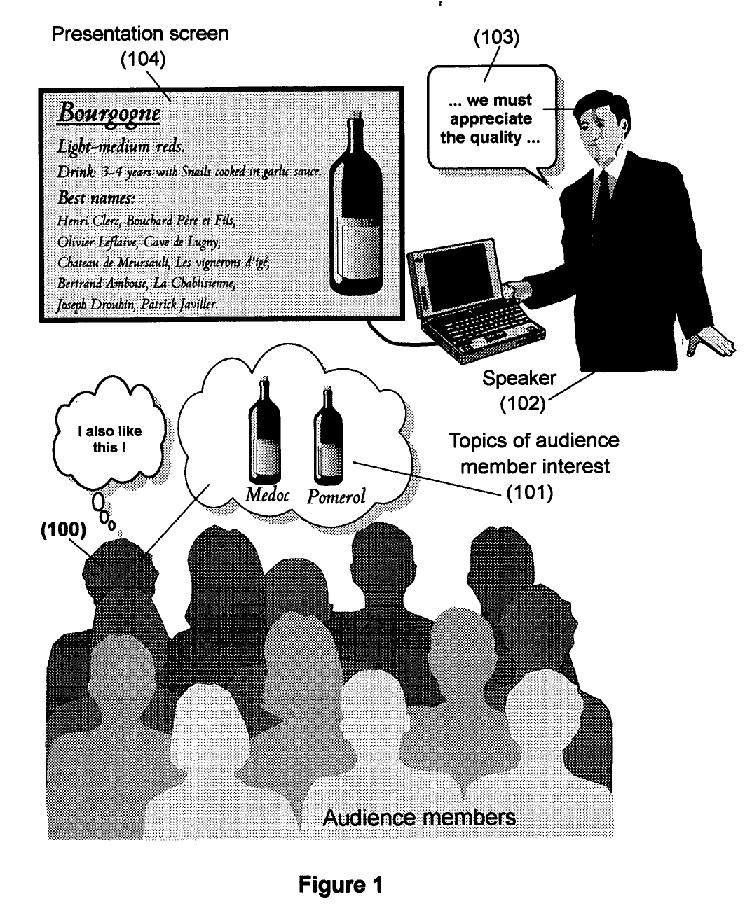

The present invention will now be described in detail with reference to the figures. As shown in FIG. 1, each audience member (or “auditor”) 100 attending a “foil” presentation is interested in one or more topics/foils which are presented. At some moments, an audience member is interested in what the speaker 102 is saying or what foil is being shown on the presentation screen 104. At other moments, the audience member is not interested because the presented topic is already known or irrelevant. In the illustrated embodiment, the audience members view the presentation when projected onto a wall or fabric screen. The present invention enables an audience member 100 to readily select the topics of interest in the course of the presentation. For example, the audience member may be interested in “Pomerol” or “Medoc” during a long presentation about “French Red Wines” and want to access, at a later time, more information related to these topics.

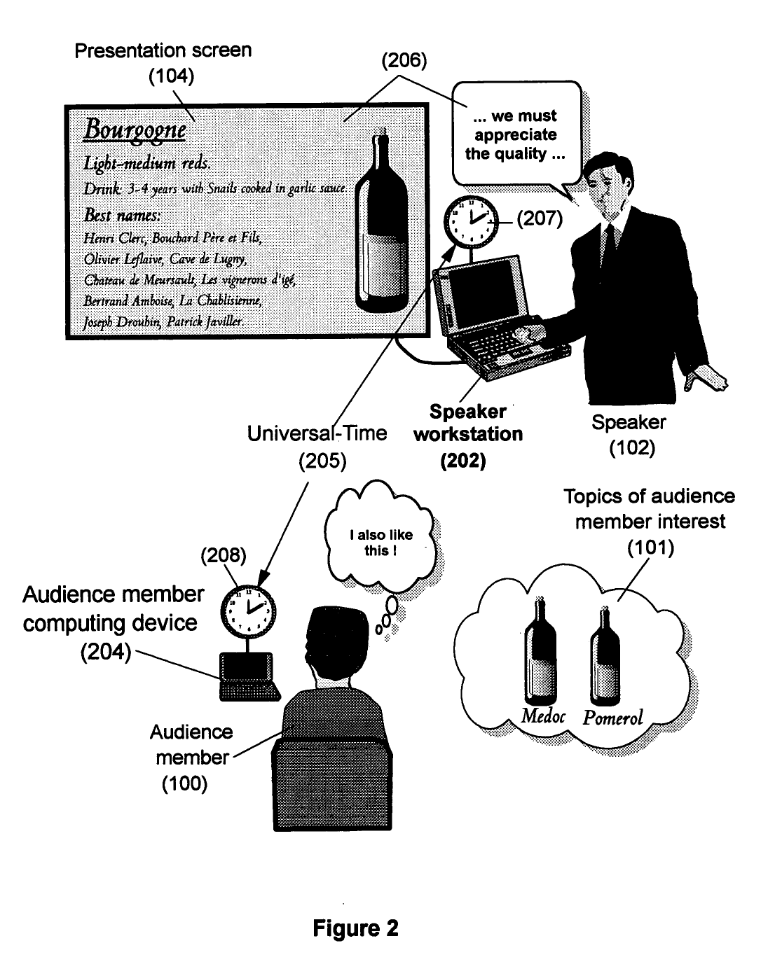

As illustrated in FIG. 2, the present invention synchronizes a speaker or presenter workstation 202, i.e. a computing system under the control of the speaker 102 or presenter including a presentation screen 104, with audience member computing devices 204, for example, a laptop computer, a PDA, a handheld computer, a wearable computer or a smart phone. In a preferred embodiment of the present invention, speaker workstation 202 and audience member's devices 204 are synchronized according to a universal time system 205, such as the Global Positioning System Time GPS-time, the Global Orbiting Navigational Satellite System GLONASS time or another suitable universal time based on a satellite system. A GPS or GLONASS receiver 207 is integrated or connected to the speaker workstation 202. On the audience member's side, GPS or GLONASS receivers 208 can be integrated or connected to the audience member 100 devices 204. In the illustrated embodiment of the present invention, the audience member devices 204 are independent of the speaker workstation 202 insofar as the presentation of the foils, i.e. they do not display the presentation foils when presented by the speaker workstation 202.

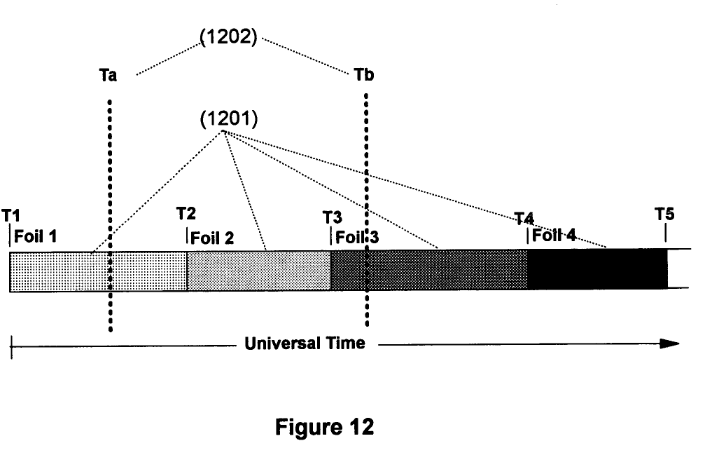

FIG. 12 also shows requests 1202 generated by an audience member 100 at universal times Ta, Tb. At these times, the audience member selects a first and a second foil/topic as being of interest, and for which the audience member subsequently wants additional information. These times are correlated with universal time intervals T1, T2, T3, (referenced also as 1201) corresponding to the presentation by the speaker of Foil 1 and Foil 3. This correlation of events is based on the synchronization of the speaker workstation 202 with the audience members devices 204 according to a universal time 205. This correlation allows the identification of the foils that have been selected by the audience member during the course of the presentation.

### Universal Timing Systems

Timing sequences, independent of locations of transmitters and receivers, can be derived from an absolute timing reference such as the Global Positioning System GPS time or the Universal Time Co-ordinated UTC time also known today as GMT and ZULU time. To transmit precise timing signals, the GPS uses twenty four satellites in 55° inclined orbits 10,000 miles above the earth. These timing signals are used by any GPS receiver anywhere on the earth to determine its position. A 1575 MHz transmission carries a 1-MHz bandwidth phase-modulated signal named the clear acquisition C/A code. When a GPS receiver receives this signal from at least three GPS satellites, it can determine its own latitude and longitude with an accuracy of about 30 meters. Apart the determination of geographical positions, the GPS is today widely used for distributing Precise Time and Time Interval PTTI. The system uses time of arrival TOA measurements for determining a position. A precisely timed clock is not essential for the user because time is obtained in addition to position by the measurement of the TOA of four satellites simultaneously in view. If the altitude over sea level is known, three satellites are sufficient. If the user is stationary at a known position then, in principle, the time can be obtained by the observation of a single satellite. Information about the GPS time service is supplied by the “Time Service Department”, U.S. Naval Observatory, Washington, D.C., at http://tycho.usno.navy.mil/.

Previously known GPS is used both as a source of time and as a means of transferring time from one location to another. Three known kinds of time are available from GPS: GPS time, UTC as estimated and produced by the United States Naval Observatory, and the times from each free-running GPS satellite's atomic clock. The Master Control Station MCS at Falcon Air Force Base near Colorado Springs, Colorado, gathers the GPS satellites' data from five monitor stations around the world. A Kalman filter software program estimates the time error, frequency error, frequency drift and Keplerian orbit parameters for each of the satellites and its operating clock. This information is uploaded to each satellite so that it can be broadcasted in real time. This process provides GPS time consistency across the constellation to within a small number of nanoseconds and accurate position determination of the satellites to within a few meters.

The second universal time standard, Universal Time Co-ordinated UTC, introduces leap seconds to remain synchronized with the rotation of the earth. In order to provide an estimate of UTC time derivable from a GPS signal, a set of UTC corrections is also provided as part of the GPS broadcast signal. This broadcast message includes the time difference in whole seconds between GPS time and UTC. This complicates software that deals with the smooth flow of data streams or calculates the times between data samples. GPS Time is preferred in this invention as this system avoids the introduction of leap seconds and is easily related to UTC. Information about UTC GMT time service can be found on: http://time.greenwich2000.com/.

### GPS Receivers

A Direct-to-Digital GPS Receiver is described in the following Web site: http://w3.research.ibm.com/present/gto200038.htm.

This is an example of a low cost chip which can integrate GPS into anything e.g., a PDA, a mobile phone, a wearable computer, a video camera. This receiver has been jointly developed between IBM and Leica. The high speed analog capabilities of SiGe technology, when integrated with the CMOS technology, allows the integration of this single chip directly to a digital GPS Global Positioning System receiver. GPS derived position information is finding a multitude of diverse applications: from mapping and surveying to vehicle tracking to 911 cell phone caller location to automated farm equipment to even robotics golf carts. This receiver chip reduces the radio dimensions and complexity. There are no analog mixer stages, nor costly discrete components such as high quality filters that conventional two stage analog down conversion would have required. Instead, the incoming GPS signal is literally digitized right at the antenna, then filtered digitally in a CMOS based chip. This direct digitization is made possible by the ability of SiGe technology to run at high speed on very little power, and the core of this technology is a SiGe based Analog to Digital Data Converter.

According to the present invention GPS or GLONASS receivers are integrated or connected to the speaker workstation 202, for example, a personal computer, and to audience member devices 204, for example, laptop computers, wearable computers, personal digital assistants (“PDAs”), smart phones, WAP enabled phones, games consoles. The universal timing signals that are received from GPS or GLONASS satellites, are used to initialize and synchronize the internal electronic clocking systems according to the same universal time. During the periods on which GPS or GLONASS satellites are out of sight e.g., when user's devices are inside buildings or not connected to an external antenna, and no timing signals are thus received from those satellites, timing information must be continuously derived from the autonomous electronic clocking systems of those devices. Depending on the drift of the clocking systems set up in the devices, and to keep enough timing precision and to be sure that audience member devices and speaker workstation are synchronized at the same universal-time, a more or less frequent periodic reception of satellite signals must be performed. In practice, if the user device is portable, satellite signals will be received when the user is out of doors or is travelling. If the user device is fixed or installed in a house or building during long periods, the user device must be connected to an outdoors installed GPS or GLONASS antenna, e.g., antenna installed on the roof of the building.

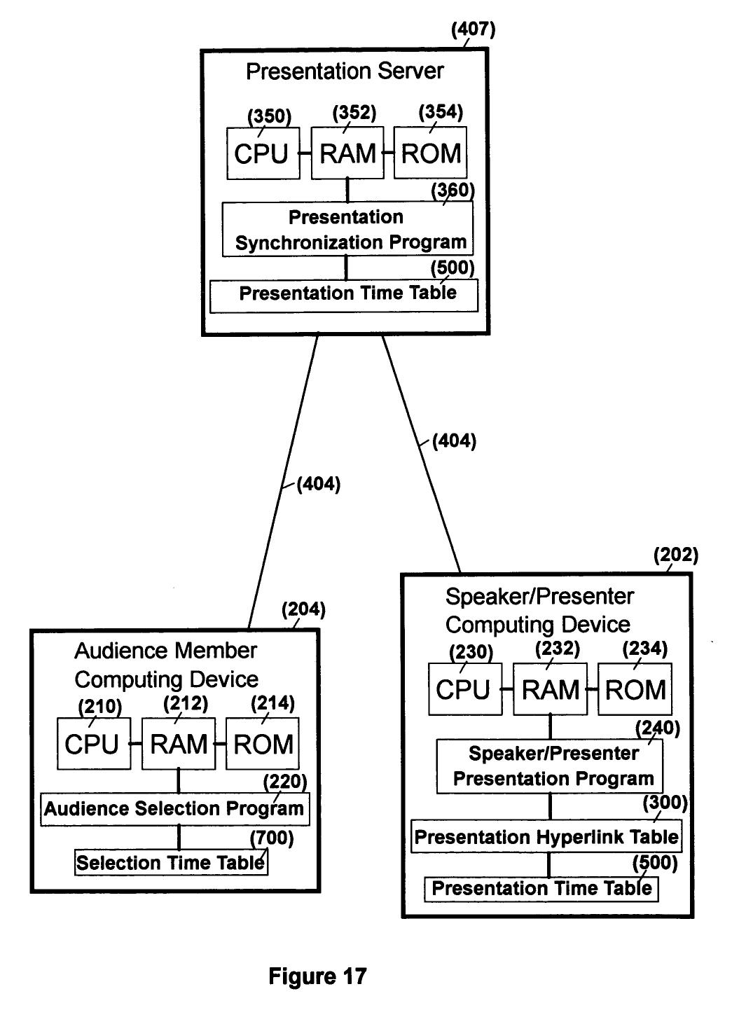

FIG. 17 illustrates internal components of audience member computing device 204. There is a CPU 210, RAM 212, ROM 214, an audience selection program 220 and a selection time table 700. The audience member uses the audience selection program 220 to request more information about foils which are currently displayed. The selection time table 700 records the timing of these requests, and forwards these request times to a presentation server 407. As explained in more detail below, the time of these requests is correlated to the foils which are currently displayed based on the start time and stop time for the display of each of the foils. The start and stop times of the presentation of each foil are recorded by the speaker/presentation computing device 202 and forwarded to the presentation server 407 where they are compared to the request times forwarded by the audience member computing device. Thus, the speaker/presenter computing device 202 includes a CPU 230, a RAM 232, a ROM 234, a speaker/presenter presentation program 240 (which records the start time and stop time for the presentation of each foil and forwards the start and stop times to the presentation server), and a presentation hyperlink table 300 which lists each potential foil in the presentation. The presentation server 407 comprises a CPU 350, a RAM 352, a ROM 354, a presentation synchronization program 360 (which identifies which foil was being displayed when each request was made by the audience member based on the time each request was made and the start time and stop time for the presentation of each foil), and a presentation time table 500 (which stores the record of the start time and stop time, supplied by the presenter presentation program 240, for the presentation of each foil.)

### Presentation Hyper link Table

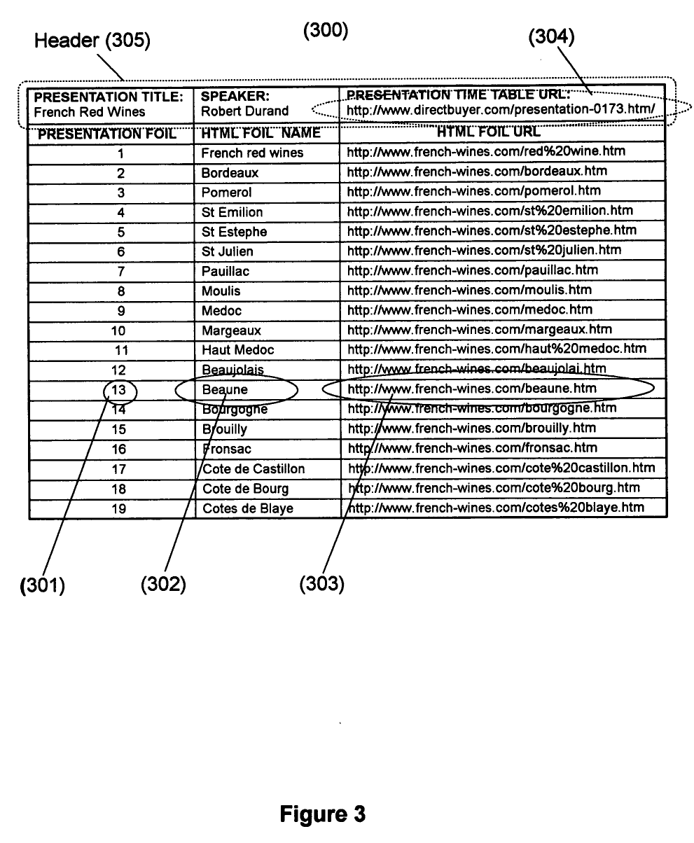

As illustrated in FIG. 3, a presentation, according to a preferred embodiment of the present invention, is structured as a set of HTML foils stored on one or a plurality Web servers. These Web servers are referenced in a Presentation Hyperlink Table 300 preferably stored on the speaker workstation 202. For each presentation foil, the Presentation Hyperlink Table encodes a foil number 301, a foil name or short title 302, and a network address i.e., a URL 303 where the HTML foil or information related to the foil can be found on the Internet network.

FIG. 3 shows an example of a Presentation Hyper link Table 300 for a presentation entitled “French Red Wines”, presented by a speaker called “Robert Durand”. During the presentation, the sequence of the foils that are presented by the speaker, is stored on a Presentation Time Table, located on a Presentation Server, at URL 304:

http://www.directbuyer.com/presentation-0173.htm/

For example, when the speaker selects the foil number “13” 301, named “Beaune” 302, the hyperlink to the URL address 303:

http://www.french-wines.com/beaune.htm

is activated. The HTML foil is retrieved from this network address and shown to the audience.

| PRESENTATION: | SPEAKER: | PRESENTATION TIME TABLE URL: |
|---|---|---|
| French Red Wines | Robert Durand | http://www.directbuyer.com/presentation-0173.htm/ |
| FOIL NUMBER | FOIL NAME | FOIL URL |
| 1 | French red wines | http://www.french-wines.com/red%20wine.htm |
| 2 | Bordeaux | http://www.french-wines.com/bordeaux.htm |
| 3 | Pomerol | http://www.french-wines.com/pomerol.htm |
| 4 | St Emilion | http://www.french-wines.com/st%20emilion.htm |
| 5 | St Estephe | http://www.french-wines.com/st%20estephe.htm |
| 6 | St Julien | http://www.french-wines.com/st%20julien.htm |
| 7 | Pauillac | http://www.french-wines.com/pauillac.htm |
| 8 | Moulis | http://www.french-wines.com/moulis.htm |
| 9 | Medoc | http://www.french-wines.com/medoc.htm |
| 10 | Margeaux | http://www.french-wines.com/margeaux.htm |
| 11 | Haut Medoc | http://www.french-wines.com/haut%20medoc.htm |
| 12 | Beaujolais | http://www.french-wines.com/beaujolai.htm |
| 13 | Beaune | http://www.french-wines.com/beaune.htm |
| 14 | Bourgogne | http://www.french-wines.com/bourgogne.htm |
| 15 | Brouilly | http://www.french-wines.com/brouilly.htm |
| 16 | Fronsac | http://www.french-wines.com/fronsac.htm |
| 17 | Cote de Castillon | http://www.french-wines.com/cote%20castillon.htm |
| 18 | Cote de Bourg | http://www.french-wines.com/cote%20bourg.htm |
| 19 | Cotes de Blaye | http://www.french-wines.com/cotes%20blaye.htm |

### Method for Creating a Presentation Hyper link Table on a Speaker Workstation

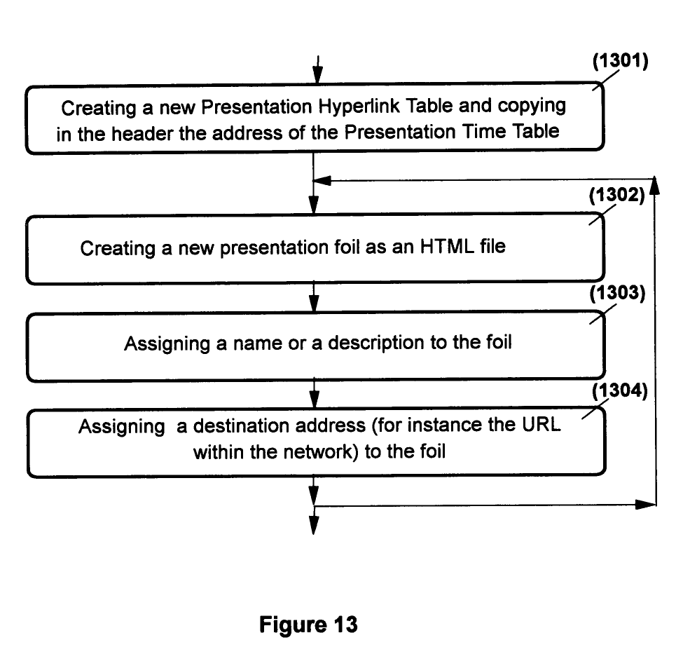

As shown in FIG. 13, the present invention discloses a method for creating a Presentation Hyperlink Table 300 for a presentation such as the presentation entitled “French Red Wines” described in the previous example and for defining, in this Presentation Hyperlink Table, hyperlinks 303 to one or a plurality of servers 403 i.e., web servers connected to a network 404 i.e., to the Internet Network where foils can be accessed. These hyperlinks can be used by the audience member 100 to access the foils i.e., web pages or HTML foils of the presentation on the servers.

The method of creating a Presentation Hyperlink Table in a speaker device and for defining, in the Presentation Hyperlink Table, hyperlinks to one or a plurality of servers where foils can be accessed, comprises the following steps illustrated in FIG. 13 with reference to FIG. 3. In step 1301, a developer creates a new Presentation Hyperlink Table 300. The Presentation Hyperlink Table includes a header 305. The Presentation Hyperlink Table also includes URL or other address information for locating and accessing within the network 304 a Presentation Time Table on a Presentation Server. The URL or other address information is preferably stored in the header 305. For each foil of the presentation, a developer creates a new record in the Presentation Hyperlink Table (step 1302). Next, the developer assigns a name 302 and/or a short description for identifying the foil (step 1303). The name or short description are copied into the record. Next, a developer specifies a URL 303 or other address information 304 within the network to locate and access the foil (step 1304). The URL or other address information are stored in the record.

### Method for Generating a Presentation Time Table on a Presentation Server

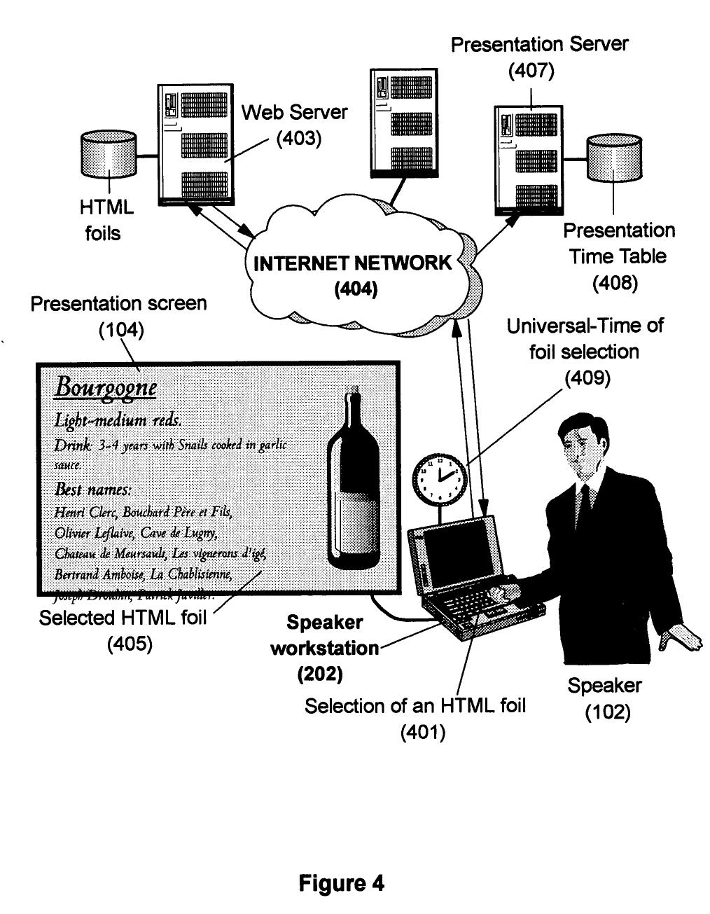

As shown in FIG. 4, the present invention also discloses a method for generating during a presentation, a Presentation Time Table 408 on a Presentation Server 407. The speaker 102 selects the HTML foils using the speaker/presenter presentation (software) program running on his or her workstation 202. Each time the speaker selects (step 401) a new foil e.g., the HTML foil number “14”, named “Bourgogne”, the speaker/presenter presentation program 240 retrieves the URL corresponding to the selected HTML foil

e.g., http://www.french-wines.com/bourgogne.htm from the Presentation Hyperlink Table 300. The speaker/presenter presentation program 240 then activates the hyperlink associated with the selected HTML foil using a browser program on the speaker workstation. The speaker/presenter presentation program 240 then accesses and retrieves the selected HTML foil 405 from the Web server 403 through the network 404 and presents the selected HTML foil 405 to the audience members on a presentation screen 104.

FIG. 4 also shows how, each time the speaker selects (step 401) a new HTML foil, the speaker/presenter presentation program 240 determines the universal-time interval 409 corresponding to the time of this selection, using the GPS receiver connected to the speaker workstation 202. The speaker/presenter presentation program 240 then retrieves the name 302 and the URL 303 of the selected HTML foil from the Presentation Hyper link Table 300 and transmits this name and URL, with the corresponding universal-time interval 409, to the Presentation Server 407. The presentation synchronization program 360 within the Presentation Server then copies the name, URL and universal-time interval 409 into Presentation Time Table 408 located on the Presentation Server. In the present example, the URL: http://www.directbuyer.com/presentation-0173.htm/ is the network address of the Presentation Time Table presentation-0173.htm stored on the Presentation Server www.directbuyer.com. (The speaker provided to the audience, the URL of the Presentation Time Table 304 before the presentation.)

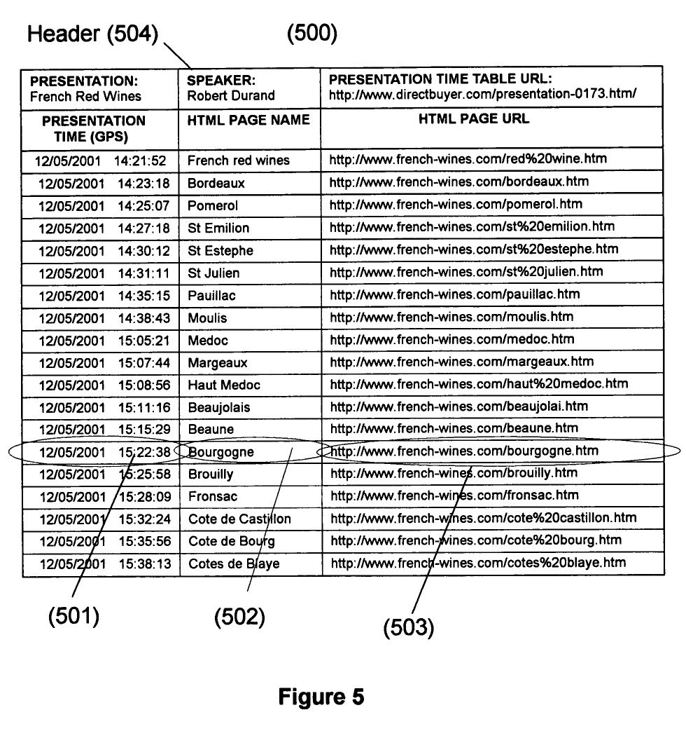

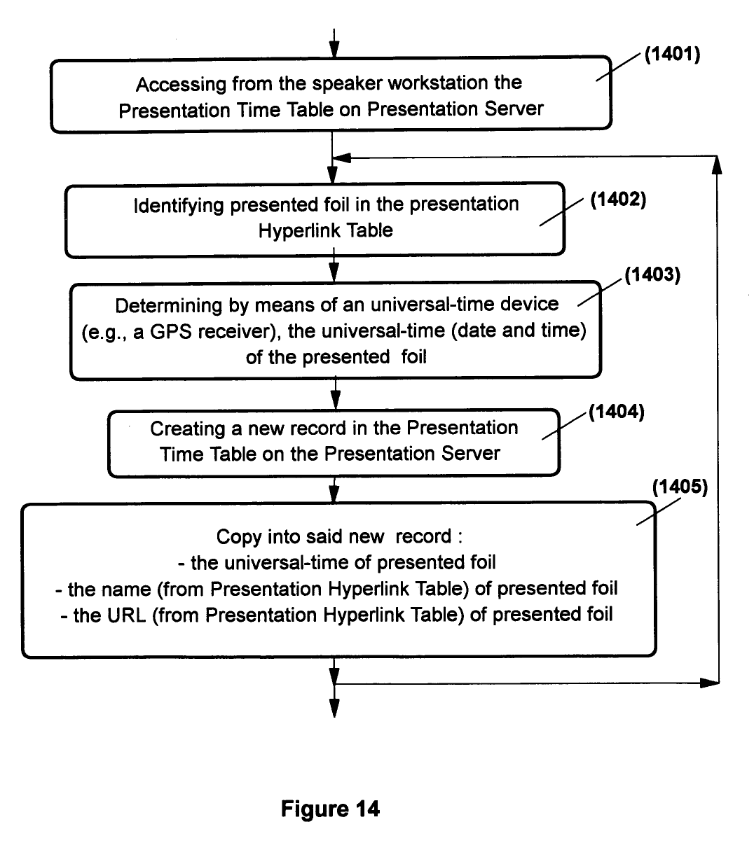

As illustrated in FIG. 14 with reference to FIGS. 4 and 5, the method for generating from a speaker device 202 a Presentation Time Table 408 on a Presentation Server 407 during the presentation of one or a plurality of foils, comprises the following steps. The speaker/presenter presentation program 240 locates and access the Presentation Hyperlink Table 300 for a specified presentation. The Presentation Hyperlink Table, preferably located in the speaker device 202, comprises an identifier 302 for one or each of a plurality of foils. Each foil is preferably identified by a name 302 and/or a short description. The Presentation Hyperlink Table also includes an identifier preferably a destination address 303 such as a URL within the network; for locating and accessing the one or plurality of foils. The Presentation Hyperlink Table also includes an identifier 304 for locating and accessing a Presentation Time Table 408 on a Presentation Server 407. In step 1401, the speaker/presenter presentation program 240 locates and accesses the Presentation Time Table 408 on the Presentation Server 407. Then, for each presented foil, the speaker/presenter presentation program 240 identifies the presented foil in the Presentation Hyperlink Table (steps 401 and 1402), determines a universal-time interval 409 corresponding to the time of presentation of the foil by means of an universal-time device e.g., a GPS receiver (step 1403), creates a new record on the Presentation Time Table 408 located on the Presentation Server 407 (step 1404), and writes into the new record the universal-time interval 501 corresponding to the presented foil, a name retrieved from the Presentation Hyperlink Table for identifying the presented foil 502, and a URL 303 retrieved from the Presentation Hyper link Table for locating and accessing the presented foil (step 1405).

FIG. 5 and the following show an example of Presentation Time Table 500 stored on a Presentation Server 407 at the end of a presentation.

| PRESENTATION: | SPEAKER: | PRESENTATION TIME TABLE URL: |
|---|---|---|
| French Red Wines | Robert Durand | http://www.directbuyer.com/presentation-0173.htm/ |
| SELECT. TIME | FOIL NAME | FOIL URL |
| 12/05/2001 14:21:52 | French red wines | http://www.french-wines.com/red%20wine.htm |
| 12/05/2001 14:23:18 | Bordeaux | http://www.french-wines.com/bordeaux.htm |
| 12/05/2001 14:25:07 | Pomerol | http://www.french-wines.com/pomerol.htm |
| 12/05/2001 14:27:18 | St Emilion | http://www.french-wines.com/st%20emilion.htm |
| 12/05/2001 14:30:12 | St Estephe | http://www.french-wines.com/st%20estephe.htm |
| 12/05/2001 14:31:11 | St Julien | http://www.french-wines.com/st%20julien.htm |
| 12/05/2001 14:35:15 | Pauillac | http://www.french-wines.com/pauillac.htm |
| 12/05/2001 14:38:43 | Moulis | http://www.french-wines.com/moulis.htm |
| 12/05/2001 15:05:21 | Medoc | http://www.french-wines.com/medoc.htm |
| 12/05/2001 15:07:44 | Margeaux | http://www.french-wines.com/margeaux.htm |
| 12/05/2001 15:08:56 | Haut Medoc | http://www.french-wines.com/haut%20medoc.htm |
| 12/05/2001 15:11:16 | Beaujolais | http://www.french-wines.com/beaujolai.htm |
| 12/05/2001 15:15:29 | Beaune | http://www.french-wines.com/beaune.htm |
| 12/05/2001 15:22:38 | Bourgogne | http://www.french-wines.com/bourgogne.htm |
| 12/05/2001 15:25:58 | Brouilly | http://www.french-wines.com/brouilly.htm |
| 12/05/2001 15:28:09 | Fronsac | http://www.french-wines.com/fronsac.htm |
| 12/05/2001 15:32:24 | Cote de Castillon | http://www.french-wines.com/cote%20castillon.htm |
| 12/05/2001 15:35:56 | Cote de Bourg | http://www.french-wines.com/cote%20bourg.htm |
| 12/05/2001 15:38:13 | Cotes de Blaye | http://www.french-wines.com/cotes%20blaye.htm |

The header section 504 of this Presentation Time Table is the same and is directly copied from the header 305 of the Presentation Hyperlink Table 300 located on the speaker workstation. Each row of the table corresponds to a foil of the presentation 300 selected by the speaker. For each selected foil, the three columns of the Presentation Time Table correspond respectively to the universal-time interval 501 at which the HTML foil has been selected by the speaker, the title, short name, or short description 502 of the selected HTML foil, and the URL or other address 503 of the selected HTML foil.

### Method for Selecting Topics of Interest

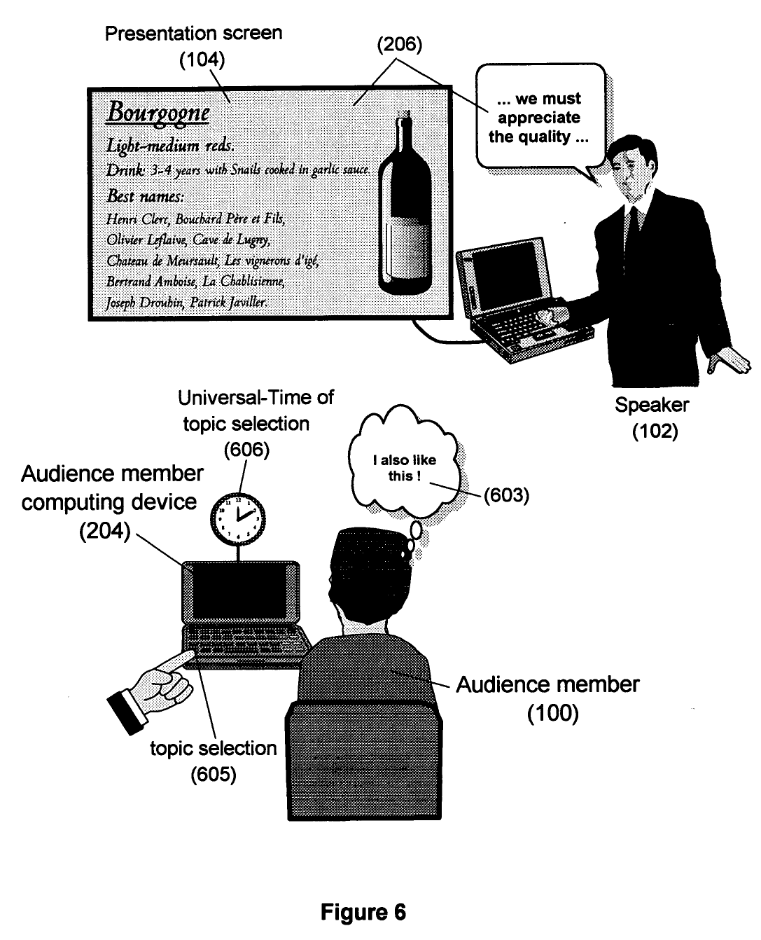

In the example illustrated by FIG. 6, during the course of the foregoing presentation, for example, the presentation entitled “French Red Wines”, an audience member 100 can use a portable workstation 204 in stand-alone mode i.e., isolated, not connected to a network. In the particular embodiment shown in this figure, each time the audience member 100 perceives 603 during the presentation done by the speaker 102, an interesting topic 206 for which he or she wants additional information, he or she selects this topic by pressing a certain key 605 on his or her portable workstation 204. In response, the audience selection program 220 on the audience member workstation 204 stores in a Selections Time Table the Universal times 606 at which the audience member selects interesting topics by pressing the key.

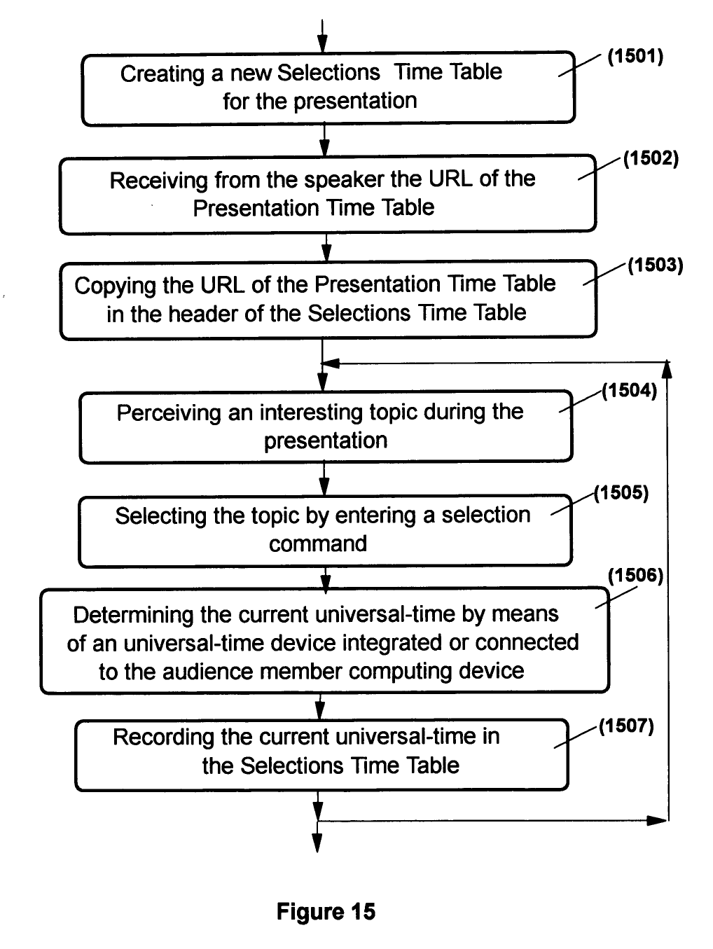

FIG. 15 shows the steps for selecting in a presentation, one or a plurality of foils corresponding to one or a plurality of interesting topics, and for accessing at a later time the selected foils. To select particular topics of interest, the audience member 100 of a presentation initiates creation on his or her workstation 204, a Selections Time Table for the presentation (step 1501). In response, the audience selection program 220 on workstation 204 receives from the speaker device 202, an identifier 304 for locating and accessing a Presentation Time Table 500 on a Presentation Server 407, preferably a destination address for instance an URL within the network (step 1502), and stores the identifier 304 for locating and accessing the Presentation Time Table 500 (step 1503). Subsequently, the audience member perceives during the presentation a topic/foil of interest 206 for which he or she desires to review the corresponding foil at a later time (step 1504), and selects the foil corresponding to the topic of interest by entering a selection command 605 on his or her workstation 204 (step 1505). In response, the workstation determines the current universal-time 606 by means of a universal-time device for instance a GPS receiver integrated or connected to his or her workstation (step 1506) and records the current universal-time in the Selections Time Table (step 1507).

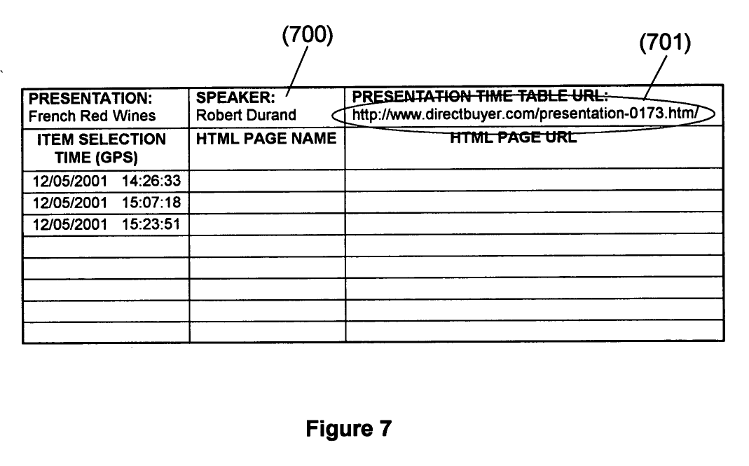

The following table, also shown in FIG. 7, is an example of Selections Time Table created on an audience member workstation 204 during the course of a presentation for instance, the presentation about “French Red Wines”. Each row of this table corresponds to a selection by the audience member, of a foil presented by the speaker at the universal-time recorded in the first column. In the header section of this table, the audience member has copied the URL 701 of the Presentation Time Table e.g., http://www.directbuyer.com/presentation-0173.htm/. This URL is provided by the speaker to the audience members in advance, before the presentation.

| PRESENTATION: | SPEAKER: | PRESENTATION TIME TABLE URL: |
|---|---|---|
| French Red Wines | Robert Durand | http://www.directbuyer.com/presentation-0173.htm/ |
| SELECTION TIME | FOIL NAME | FOIL URL |
| 12/05/2001 14:26:33 | | |
| 12/05/2001 15:07:18 | | |
| 12/05/2001 15:23:51 | | |

### Method for Accessing and Displaying Selected Foils

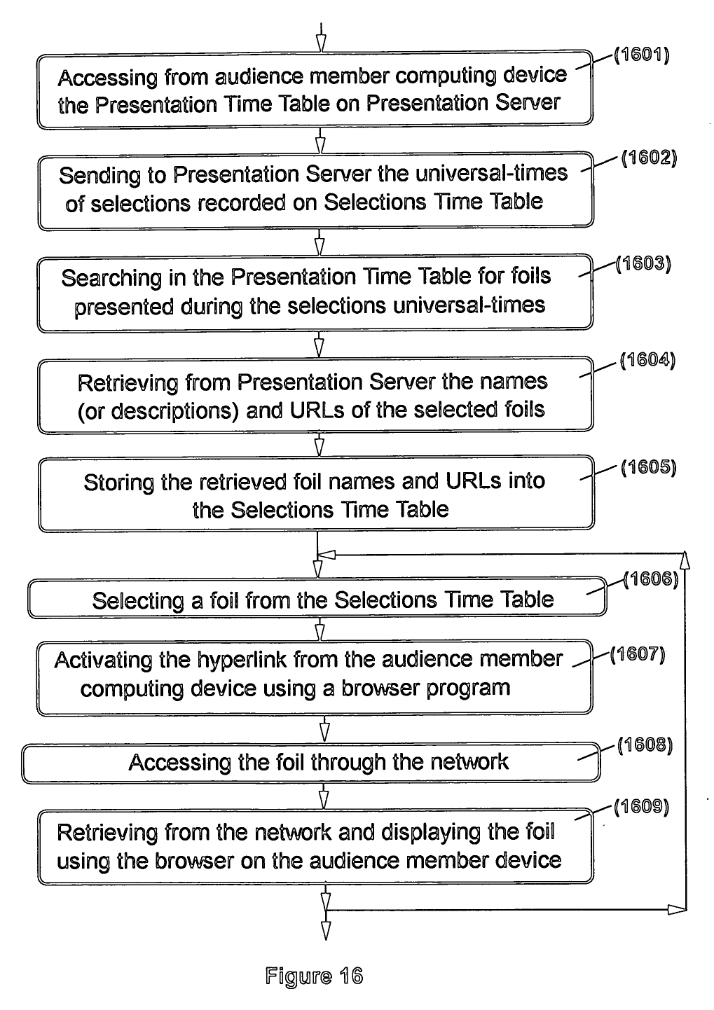

Once the audience member 100 has selected one or a plurality of topics of interest 206 during a presentation (such as the presentation entitled “French Red Wines”), and once the universal-times 606 corresponding to these selected topics have been stored or recorded in the Selections Time Table 700 on the audience member workstation 204, by means of the method described in FIG. 16, the audience member or viewer can retrieve from the Presentation Server 407 the names and URLs associated with the selected foils. The retrieved names and URLs are then locally stored in the Selections Time Table 700 on the audience member workstation 204. From the updated Selections Time Table, the audience member can select, retrieve and display anyone of the foils.

The method for an audience member of a presentation, of accessing and displaying selected foils from a workstation, comprises the following steps. The audience selection program 220 accesses from the workstation 204, the Presentation Time Table 408 on the Presentation Server 407 (step 1601). The audience selection program 220 sends to the Presentation Server 407, the universal-times of the selections recorded on the Selections Time Table 700 located on the workstation 204 (step 1602). The presentation synchronization program 360 within the Presentation Server searches in the Presentation Time Table for the foils that were presented at these universal-times (step 1603). The presentation synchronization program 360 then sends to the audience selection program 220 the identifier for the selected foils names or descriptions 502 and the associated URLs 503 (step 1604). The audience selection program 220 stores the retrieved foil names and URLs into the Selections Time Table 902 (step 1605). Then, the audience member selects a foil 1001 from the Selections Time Table 804 (step 1606) and activates the hyperlink 1003 from the workstation using a browser program (step 1607). Then, the audience member's web browser accesses the foil on a server 403 preferably a Web server through the network 404 preferably the Internet network (step 1608), retrieves the web page from the network 1101 and displays the foil 1104 on the workstation using a browser program (step 1609).

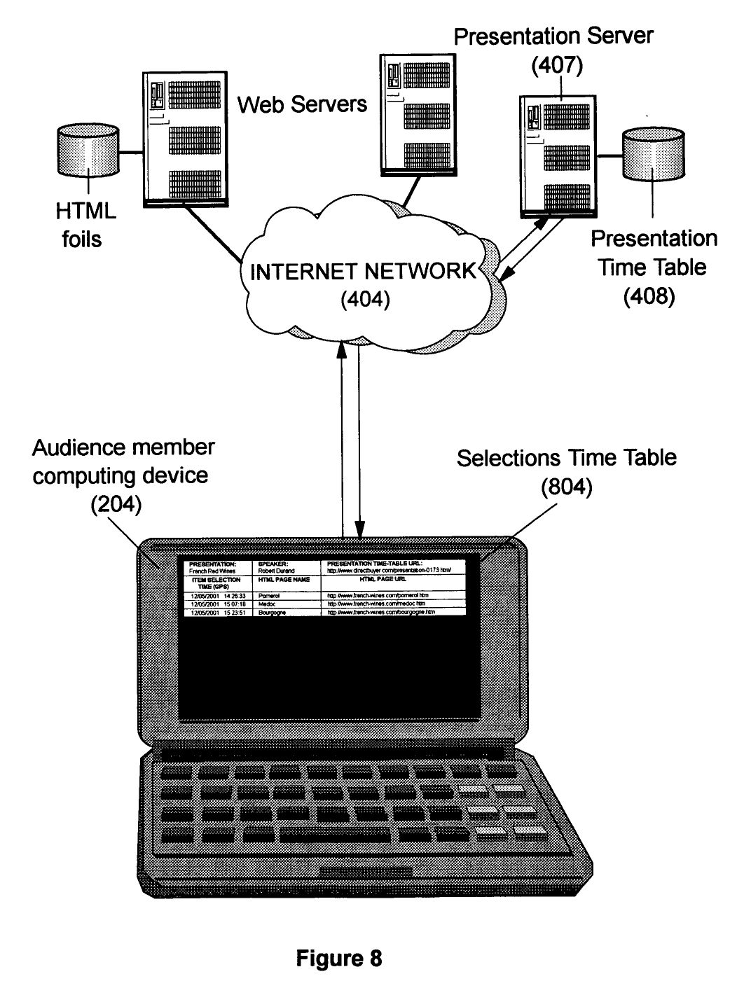

FIGS. 8, 9, 10 and 11 illustrate the different steps according to the present method. As illustrated in FIG. 8, when the “French Red Wines” or other presentation ends, the audience member connects his or her workstation 204 to a communications network e.g., the Internet network 404. Then, the audience selection program 220 running on his or her workstation requests information from the Presentation Time Table 408 on the Presentation Server 407 based on the selections in the Selections Time Table 804.

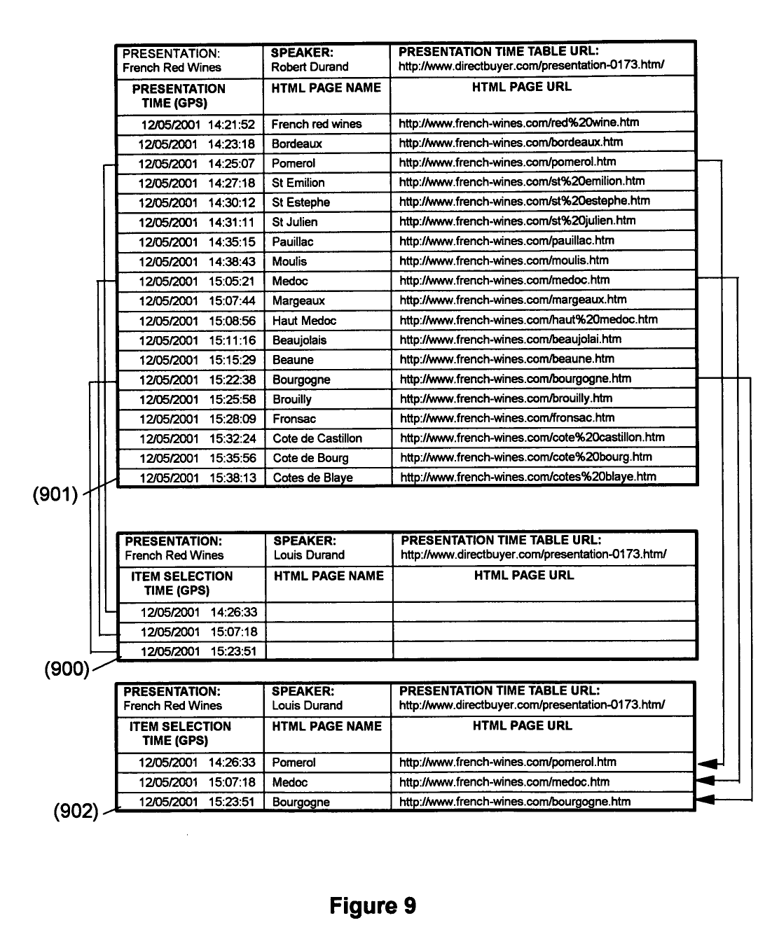

FIG. 9 illustrates the process of updating the Selections Time Table 900 on the audience member workstation 204 using the information stored in the Presentation Time Table 901 located on the Presentation Server 407. For each universal-time recorded in the Selections Time Table 900, the name and the URL of the HTML foil that was being presented by the speaker at that time, are identified on the Presentation Time Table 901 and are copied into the Selections Time Table 902. The following table shows a Selections Time Table, updated by means of this process:

| PRESENTATION: | SPEAKER: | PRESENTATION TIME TABLE URL: |
|---|---|---|
| French Red Wines | Robert Durand | http://www.directbuyer.com/presentation-0173.htm/ |
| SELECTION TIME | FOIL NAME | FOIL URL |
| 12/05/2001 14:26:33 | Pomerol | http://www.french-wines.com/pomerol.htm |
| 12/05/2001 15:07:18 | Medoc | http://www.french-wines.com/medoc.htm |
| 12/05/2001 15:23:51 | Bourgogne | http://www.french-wines.com/bourgogne.htm |

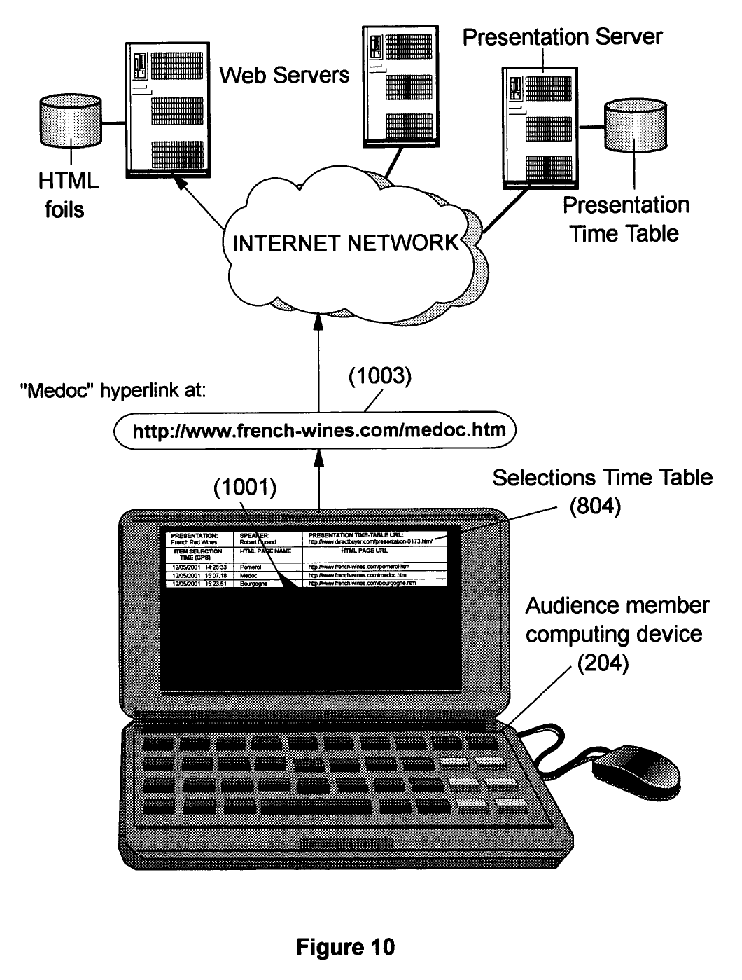

FIG. 10 illustrates how the audience member selects and accesses, from his or her workstation 204, HTML foils previously selected during the presentation. The audience member points to and selects an HTML foil 1001 on the updated Selections Time Table 804. By means of the audience selection program 220 and web browser located on his or her workstation 204, he or she activates the hyperlink 1003 pointing to the URL of the selected item 1001. In the example shown in FIG. 10, the audience member selects the topic of interest “Medoc” 1001 (which is a type of French red wine) and activates the hyperlink 1003 pointing to the URL: http://www.french-wines.com/medoc.htm.

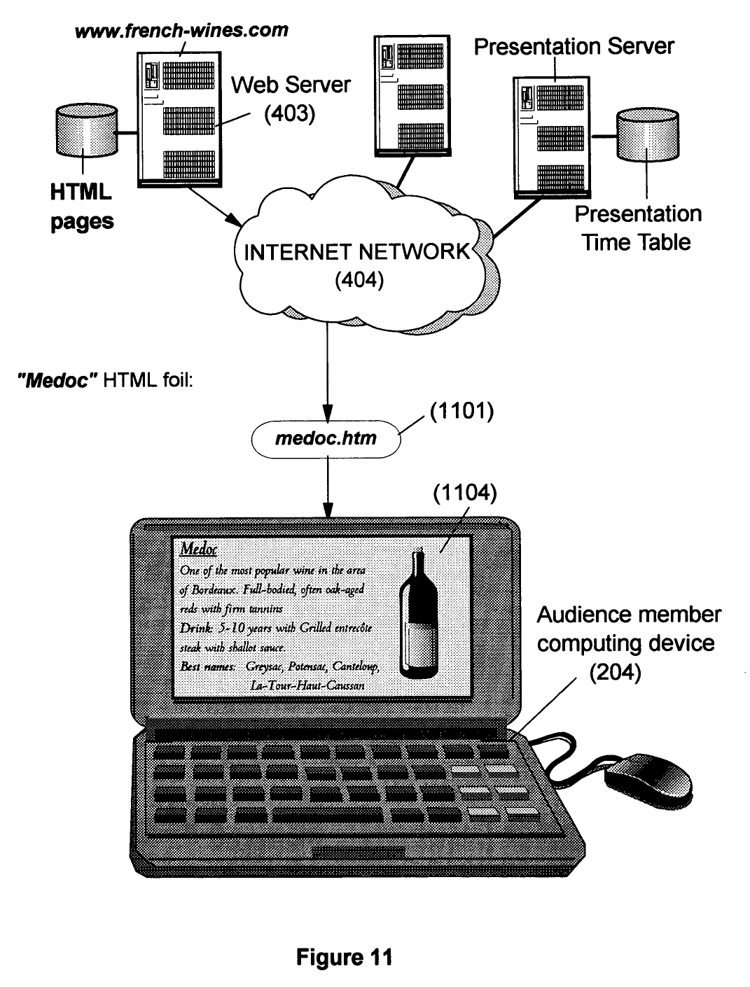

Finally, FIG. 11 shows how an HTML foil 1101 e.g., medoc.htm associated with the item selected 1001 in the Selections Time Table 804, e.g., “Medoc”, is received from a Web server, e.g., www.french-wines.com, through the network 404 and is finally displayed 1104 on the audience member workstation 204.

In the previous examples, it has been shown that after the presentation, the audience member can access the foils previously selected during the course of the presentation. For example, while the speaker is presenting the foil “Bourgogne wines”, if the audience member requests to obtain additional information, when the presentation is over, the audience member can retrieve the HTML foil that was presented when the selection was made, a detailed HTML document comprising a description concerning La Bourgogne geography, history, economy, agriculture and the wines from this region, and a list of references hyper links to several Web documents or multimedia concerning “Les vins de la Bourgogne”.

While the invention has been particularly shown and described with reference to a preferred embodiment, it will be understood that various changes in form and detail may be made therein without departing from the spirit, and scope of the invention.

1. A method of supplying information to an audience member, said method comprising the steps of:
using a first computing device, initiating presentation of a plurality of informational screens during respective time intervals to the audience member;
said first computing device recording start and stop times for the presentation of each of said informational screens;
during the presentation of one of said informational screens, the audience member, using a second computing device, requesting additional information about said one informational screen, and in response, said second computing device recording a time that said audience member made the request; and
comparing the time that said audience member made the request to the start and stop times for the presentation of each of said informational screens, and based on the comparison, determining that said audience member made said request during the presentation of said one presentation screen.

2. A method as set forth in claim 1 wherein based on the determining step, supplying to said second computing device said additional information about said one informational screen or hyper links to said additional information about said one informational screen.

3. A method as set forth in claim 1 wherein said first and second computing devices are coupled to a server, said first computing device supplies to said server a list of said informational screens that are presented and the start and stop times for the presentation of each of said informational screens, said second computing device supplies to said server the recorded time that said audience member made the request for said additional information, and said server supplies to said second computing device said additional information about said one informational screen or hyper links to said additional information about said one informational screen.

4. A method as set forth in claim 1 wherein said first computing device initiates display of said presentation screens to both a presenter and said audience member from a common screen.

5. A method as set forth in claim 1 wherein said start and stops times recorded by said first computing device are derived from a first GPS receiver local to said first computing device, and said time recorded by said second computing device is derived from a second GPS receiver local to said second computing device.

6. A system for supplying information to a user, said system comprising:
a first computing device for an audience member;
a second computing device for a presenter, said second computing device including means for displaying a plurality of information screens during respective time intervals and recording approximate start and stop times for the display of each of said informational screens; and wherein
said first computing device includes means for receiving during the presentation of each of said informational screens, a request by said audience member for additional information about a currently displayed informational screen, and in response, said first computing device recording a time that said audience member made the request; and
means for comparing the time that said audience member made the request to the recorded start and stop times for the presentation of each of said informational screens, and determining the informational screen that was displayed when said audience member made said request.

7. A system as set forth in claim 6 further comprising means, based on said determination, for supplying to said first computing device said additional information about said informational screen that was displayed when said audience member made said request or hyper links to said additional information about said informational screen that was displayed when said audience member made said request.

8. A system as set forth in claim 6 further comprising:
a first GPS receiver coupled to said first computing device to determine said start and stops times recorded by said first computing device; and
a second GPS coupled to said second computing device to determine said time recorded by said second computing device.

9. A computer program product for supplying information to a user, said computer program product comprising:
a computer readable medium;
first program instructions for execution in a first computing device of an audience member;
second program instructions for execution in a second computing device of a presenter to initiate display of a plurality of information screens during respective time intervals as selected by the presenter, and record approximate start and stop times of the display of each of said informational screens; and wherein
said first program instructions receive, during the presentation of any of said informational screens, a request by said audience member for additional information about a currently presented informational screen, and in response, record a time that said audience member made the request; and further comprising
third program instructions to compare the time that said audience member made the request to the recorded start and stop times for the presentation of each of said informational screens, and determine which informational screen was presented when said audience member made said request; and wherein
said first, second and third program instructions are recorded on said medium.

10. A computer program product as set forth in claim 9 further comprising fourth program instructions, based on the determination of which informational screen was presented when the request was made, to initiate forwarding to said first computing device said additional information about said informational screen which was presented when the request was made or hyper links to said additional information about said informational screen which was presented when said request was made; and wherein said fourth program instructions are recorded on said medium.

11. A computer program product as set forth in claim 9 wherein said start and stops times recorded by said second program instructions are derived from a first GPS receiver local to said first computing device, and said time recorded by said first program instructions is derived from a second GPS receiver local to said second computing device.
